(19) United States
(12) Patent Application Publication
(10) Pub. No.: US 2017/0238766 A1
(43) Pub. Date: Aug. 24, 2017

(54) Spa Cushion

(71) Applicant: LMI IP, LLC, WINTER PARK, FL (US)

(72) Inventors: Gary Harder, Lake Mary, FL (US); David A. Wright, Lakeland, FL (US)

(73) Assignee: LMI IP, LLC, WINTER PARK, FL (US)

(21) Appl. No.: 15/047,772

(22) Filed: Feb. 19, 2016

(51) Int. Cl. A47K 3/12; A47C 5/12; B29C 41/46; B29C 41/36; B29C 41/38; B29C 41/42; A47C 7/02; B29C 41/06

(52) U.S. Cl. CPC A47K 3/125; A47C 7/021; A47C 5/12; B29C 41/06; B29C 41/36; B29C 41/38; B29C 41/42; B29C 41/46; A61H 33/60

(57) ABSTRACT

A cushion for a hot tub or spa is molded in a rotational molding process. The cushion includes a decorative outer surface made from a plastic material (e.g., an outer wall and side walls, etc.). The cushion includes a a back surface for interfacing with a hot-tub shell or spa shell with at least one projection extending from the back surface towards the decorative surface. The at least one projection is for supporting the force of an object that is resting on the cushion. The cushion if formed in a rotational molding process.

### FIELD

This invention relates to the field of aquatic systems and more particularly to a cushion for attachment and/or use with such aquatic systems.

### BACKGROUND

Many people take advantage of aquatic systems known as pools, hot-tubs, baths, spas, etc. In some usage scenarios, people lounge in seats formed in such systems, especially in hot-tubs and spas. The seats are formed when the shell of the hot-tub or spa is molded and is generally made out of the same resin that the hot-tub or spa is made from, for example, a resin or fiberglass. This material is typically very hard and provides little comfort.

When purchasing a spa or hot-tub, often the buyer will try sitting in the spa or hot-tub to see how it feels. Being that there is no water in the spa or hot-tub, there is no buoyancy and the full weight of the buyer is placed on the spa or hot-tub seat, which is typically a hard resin material. In many cases, the buyer disqualifies the spa or hot-tub because it feels uncomfortable, when the same spa or hot-tub may be very comfortable when filled with water, which provides a certain amount of buoyancy.

To improve comfort (even when dry), some hot-tubs or spas have cushions that are attached in the seat area. Most cushions or pillows are placed above the water line, as the heat and chemicals used in spas and hot-tubs will quickly discolor and/or degraded such cushions and pillows located below the water line. One reason for this degradation is the material that is used to make these cushions or pillows. These cushions are usually made of a soft material that is dissimilar from the material from which the hot-tub or spa is made.

The prior cushions are typically produced in a variety of models. One model is a simple sheet of rubbery material or spongy material that covers a portion of the seat area. Another model is a water-resistant outer layer (e.g., vinyl) with a foam material inside. Still another model is an air-filled bladder, typically made of a rubber material.

Although the prior hot-tub or spa cushions have some ability to improve comfort, there are many disadvantages associated with the structure and material of these cushions. Hot-tubs and spas are very harsh environments with typical temperatures between 90 degrees and 106 degrees (F.). This heat, coupled with high humidity and spa chemicals, works to degrade materials typically used for spa cushions such as vinyl and rubber. Also, in using different materials in the cushion than in the spa shell makes it is difficult to color match between the hot-tub and spa shell and the cushions and the cushion often fails long before the hot-tub or spa shell.

Often, after a relatively short interval of usage, edges and corners of the prior cushions wear, allowing air and moisture penetration into the inside of these cushions. For those cushions that rely upon air to provide the cushion (e.g., air-filled bladders), such penetrations result in a useless cushion filled with spa water. For cushions filled with foam, the foam becomes saturated, reducing the comfort provided by the cushion and creating a breeding ground for mold and bacteria.

What is needed is a cushion that will perform under the extreme conditions found in such aquatic systems.

### SUMMARY

In one embodiment, a cushion is disclosed. The cushion includes a decorative outer surface made from a plastic material (e.g., an outer wall and side walls, etc.). The cushion includes a a back surface for interfacing with a hot-tub shell or spa shell with at least one projection extending from the back surface towards the decorative surface. The at least one projection is for supporting the force of an object that is resting on the cushion.

In another embodiment, a cushion molded in a rotational molding process is disclosed. The cushion has a plurality of walls and an outward surface made from a plastic material (e.g., a decorative surface) and a back surface for interfacing with a hot-tub shell or spa shell. There are projections extending from the back surface of the cushion towards the outward surface. The projections provide support to the outward surface when an object that is resting on the outward surface applies force onto the outward surface. The cushion if formed in a mold in which an amount of the plastic material is placed in the mold and the mold is heated and rotated in two directions in a rotational molding process.

In another embodiment, a method of forming a cushion is disclosed including placing a shot of a plastic material in a two-piece mold. A cover of the two-piece mold has surfaces that form a decorative surface of the cushion and a base of the two-piece mold has a plurality of projection fingers for forming projections that project from a back surface of the cushion towards the decorative surface of the cushion. Next, the two-piece mold containing the plastic material is closed and then the two-piece mold is heated while rotating the two-piece mold such that the plastic material within the two-piece mold melts and evenly coats inside surfaces of the two-piece mold. After cooling, the cover of the two-piece mold is separated from the base of the two-piece mold and the completed cushion is removed.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of a closed roto-mold for producing a cushion.

FIG. 2 illustrates a opening of the roto-mold to release the cushion.

FIG. 3 illustrates a cut-away view of the roto-mold and resulting cushion.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

There are many types of aquatic systems, both natural and man-made, including pools, hot-tubs, baths, spas, lakes, etc. The disclosed spa cushion improves comfort for those resting in such aquatic systems. For brevity and clarity, the following description will describe the cushion as a spa cushion and the targeted application as a spa, but this is in no way limiting the present invention to usage scenarios of spas, as the same spa cushion is anticipated for use in any aquatic system, natural or man-made.

The disclosed cushion is molded using a material such as polyethylene, vinyl, and Ethylene-vinyl acetate, all of which resists color change and deterioration, even when used below the water surface. Polyethylene is an idea material for the manufacture of the disclosed cushion because of these properties, because it is flexible in the thicknesses needed for such cushions, and because polyethylene molds properly in the described manufacturing procedures.

The preferred method of producing the cushion is through rotational molding. A rotational mold is often used for molding spa shells. In such, a mold is filled with a charge or shot of material (e.g. a plastic), and then the mold is heated while the mold is rotated around two axis causing the charge or shot of material to spread and stick to the heated walls of the mold. Therefore, any part of the mold system that is made of, for example, metal, absorbs enough heat to melt and accumulate portions of the material (plastic). After cooling, the mold is opened (pulled apart) and the spa shell is extracted.

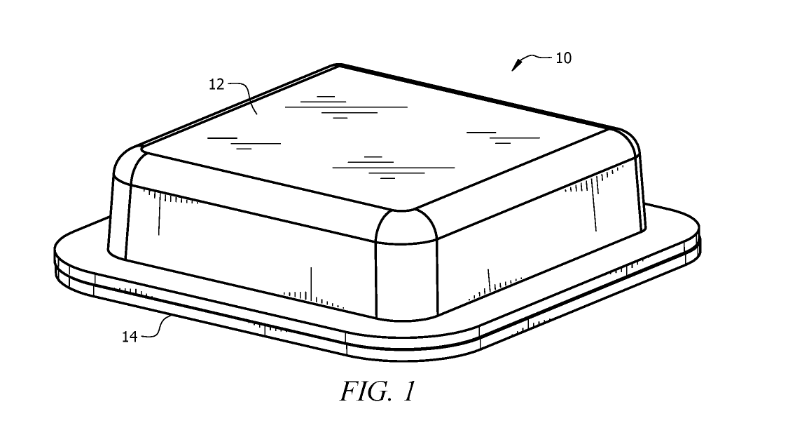

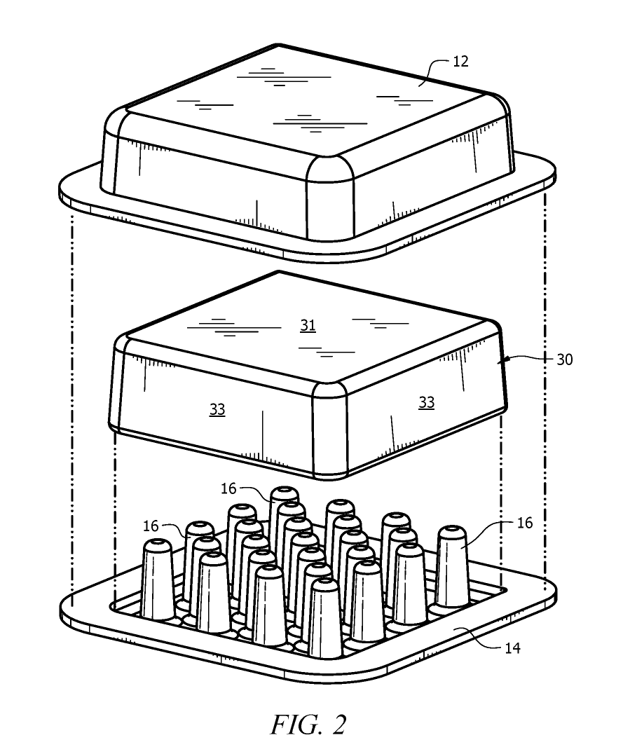

A similar process is used to produce the spa cushion. In FIG. 1, a view of a closed mold 10 is shown closed and ready to produce the cushion 30 (see FIG. 2). In this, a shot of the molding material (a material such as polyethylene, vinyl, and Ethylene-vinyl acetate), typically in granular form, is placed in the mold 10 and the mold cover 12 is held against the mold base 14 and the mold 10 is mold 10 is rotated while being heated. As the molding material melts, the molten material adheres to the inside surfaces of the mold 10, forming whatever shape that is dictated by the interior shape of the mold 10.

In FIG. 2, the molding process is complete and the mold cover 12 is separated from the mold base 14, freeing the finished cushion 30. The thickness of the walls of the cushion 30 is determined by the amount of molding material (a material such as polyethylene, vinyl, and Ethylene-vinyl acetate) placed within the mold 10 at the beginning of the process. It is anticipated that the thickness of the walls of the cushion 30 are sufficiently thin as to provide flexibility to the resulting cushion 30, otherwise the cushion 30 would not improve comfort. In this way, as a person rests against the cushion 30, the walls 33 and outward surface 31 of the cushion 30 flex, absorbing and equalizing forces of the person. The walls 33 and outward surface 31 of the cushion 30 form the decorative outer surface of the cushion 30

In a preferred embodiment, one section of the mold 10 (the mold base 14 in this example) has projections 16 that produce similar cushion projections 32 in the cushion 30. From the visible surfaces of the cushion 30, the sides 33 and outward surface 31 are substantially smooth, as shown in FIG. 2. The back surface 35 that is mounted against the spa shell is irregular from the projections, but the user does not typically see the back surface 35 of the cushion 30. In some embodiments, the projections 16 are conical in shape or dome-shaped as shown in FIG. 2.

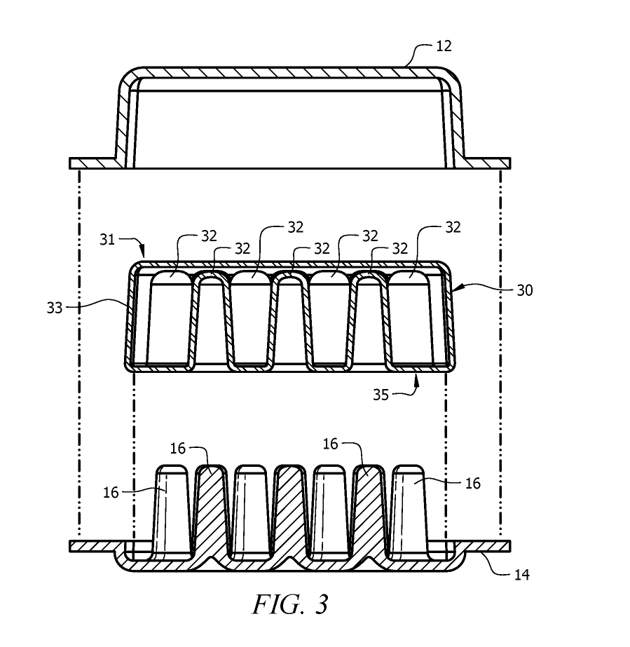

A cross-sectional view of the mold 10 and a cushion 30 produced in the mold 10 is shown in FIG. 3. In this example, the inside surface of the mold cover 12 is substantially smooth, though in some embodiments, the inside surface of the mold cover is textured to provide texture to the resulting cushion 30, for example, a leather-looking texture, etc. In this example, the mold base has multiple rows of molding projections 16 (as shown, three molding projections 16 are cut in this cross-section and the three molding projections 16 behind those are visible between each of the three molding projections 16 that are cut). During the molding process, as the molding material melts and the mold 10 is rotated in both axis, the molding material coats the molding projections 16 and forms cushion projections 32.

The resulting cushion 30 has substantially smooth side walls 32 and outward surfaces 31, an irregular back surface 35 and a plurality of cushion projections 32 emanating from the irregular back surface 35 and ending before touching the inner surface of the outward surface 31. The cushion projections 32 provide resistance to the outward surface 31 as force is expended on the outward surface, for example, when a user rests against the cushion 30. The cushion projections 32 even the force by providing uniform resistance across the outward surface 31. The cushion projections 32 provide significant comfort improvement, especially in larger cushions 30 (e.g. a whole-body cushion 30) in which, without the cushion projections 32, the wide surface of the outer surface 31 would either need to be so stiff as to not provide any cushioning or it would give too easy, providing no cushioning. It is anticipated that, for some small cushions 30 such as head cushions 30, there is very few or no cushion projections 32, as the resistance of the outer surface 31 is sufficient to support the force of a user's head.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A cushion for aquatic use, the cushion comprising:
a decorative outer surface made from a plastic material;
a back surface for interfacing with a hot-tub shell or spa shell; and
at least one projection extending from the back surface towards the decorative surface, the at least one projection for supporting the force of an object that is resting on the cushion.

2. The cushion of claim 1, wherein the plastic material is polyethylene.

3. The cushion of claim 1, wherein the plastic material is vinyl.

4. The cushion of claim 1, wherein the plastic material is Ethylene-vinyl acetate.

5. The cushion of claim 1, wherein the at least one projection is a conical-shaped projection.

6. The cushion of claim 1, wherein the at least one projection is a dome-shaped projection.

7. A cushion molded in a rotational molding process, the cushion comprising:
a plurality of walls and an outward surface made from a plastic material;
a back surface for interfacing with a hot-tub shell or spa shell; and
a plurality of projections extending from the back surface towards the outward surface, the projections providing support to the outward surface when an object that is resting on the outward surface applies force onto the outward surface;
whereas the cushion if formed in a mold in which an amount of the plastic material is placed in the mold and the mold is heated and rotated in two directions in a rotational molding process.

8. The cushion of claim 7, wherein the plastic material is polyethylene.

9. The cushion of claim 7, wherein the plastic material is vinyl.

10. The cushion of claim 7, wherein the plastic material is Ethylene-vinyl acetate.

11. The cushion of claim 7, wherein the at least one projection is a conical-shaped projection.

12. The cushion of claim 7, wherein the at least one projection is a dome-shaped projection.

13. A method of forming a cushion comprising:
placing a shot of a plastic material in a two-piece mold, a cover of the two-piece mold having surfaces that form a decorative surface of the cushion and a base of the two-piece mold having a plurality of projection fingers for forming projections that project from a back surface of the cushion towards the decorative surface of the cushion;
next, closing the two-piece mold containing the plastic material;
next, heating the two-piece mold while rotating the two-piece mold such that the plastic material within the two-piece mold melts and evenly coats inside surfaces of the two-piece mold; and
next, after cooling, separating the cover of the two-piece mold from the base of the two-piece mold and removing the completed cushion.

14. The method of claim 13, wherein the plastic material is polyethylene.

15. The method of claim 13, wherein the plastic material is vinyl.

16. The method of claim 13, wherein the plastic material is Ethylene-vinyl acetate.

17. The method of claim 13, wherein the projection fingers are of a conical-shape.

18. The method of claim 13, wherein the projection fingers are of a dome-shape.
